(19) United States
(12) Patent Application Publication
(10) Pub. No.: US 2021/0342743 A1
(43) Pub. Date: Nov. 4, 2021

(54) MODEL AGGREGATION USING MODEL ENCAPSULATION OF USER-DIRECTED ITERATIVE MACHINE LEARNING

(71) Applicant: COALESCE, INC., Dedham, MA (US)

(72) Inventor: Gregory J. Woolf, North Easton, MA (US)

(21) Appl. No.: 17/279,520

(22) PCT Filed: Sep. 25, 2019
(86) PCT No.: PCT/US2019/053043

§ 371 Date: Mar. 24, 2021

Related U.S. Application Data
(60) Provisional application No. 62/736,456, filed on Sep. 25, 2018.

(51) Int. Cl. G06N 20/00; G06F 16/245; G06F 16/215

(52) U.S. Cl. CPC G06N 20/00; G06Q 30/0185; G06F 16/215; G06F 16/245

(57) ABSTRACT

The present invention relates to model aggregation tools utilizing model encapsulation of user-directed iterative (UDI) machine learning, and the related methods that offer a typical user, without programming expertise, the ability to create and modify machine learning models. In particular, the present invention further provides methods and tools that not only afford machine learning models that are easily created and configured without the necessity of hard coding by the user, but also to afford the user with the ability to share their “know-how” derived from these models to collectively improve the models while maintaining privacy by obscuring the original training data, so that no confidential or proprietary information is shared between users of this collective model. Users may thereby rapidly teach the machine learning models to interpret their data without programming, personalizing the system's analysis and filtering capabilities, and then encapsulate their domain expertise in machine learning models that can be leveraged at scale and shared throughout a single or across multiple enterprises.

### RELATED APPLICATIONS

This application claims priority to U.S. Provisional Patent Application No. 62/736,456, filed on Sep. 25, 2018; the entirety of which is incorporated herein by reference.

### BACKGROUND OF THE INVENTION

Machine learning has become a staple tool of expert programmers in order to build learning models that offer a user the ability to apply the model to a database and make data-driven predictions or decisions, rather than following strictly static program instructions. In order to create and modify modern machine learning models, the machine learning models rely heavily on programming, also referred to as ‘hard coding’ the training of the machine learning model. In this respect, these models are built in sophisticated programming languages, and then refined utilizing programming of the machine learning model through challenging processes, as well as advanced development skills.

Creating a modern machine learning model is typically achieved by importing at least one set of initial inputs, also referred to as ‘training data,’ from a data source. The training data is then processed and prepared for training the machine learning model, ultimately, generating a machine learning model that uses one or more types of statistical analyses (including but not limited to naïve Bayesian, neural network, or a maximum entropy) capable of predicting outcomes. The accuracy of the machine learning model is then tested by applying the machine learning model to a new set of data (i.e., a set of data different from the training data set), and verifying the model-predicted outcome. This process requires programming expertise and takes considerable time, including input (e.g., related to the goals of the predictive modeling, the training data, the validation data, and the accuracy of the model predictions or output) from the users who wish to have the model created, as they are often not the programmers.

As such, it is very slow to create new machine learning models, in part because doing so requires time and expertise in programming. A typical user, or potential user, of a machine learning model does not have the capability to create or program a machine learning model directly, as doing so requires extensive programming effort and skills to achieve the results desired as the output of the machine learning model. Consequently, a typical user must hire one or more programmers to create a machine learning model. Additionally, because of the programming expertise (and resultant expense) required to create machine learning models, users will typically make or have made a relatively limited number of machine learning models—often only one. What is more, even when a typical user engages one or more programmers to create one or more machine learning models, neither the programmers nor the users are able to easily configure or change the machine learning models with new input or with the output from the machine learning models in order to modify the machine learning models, except by expertly modifying the programming through regenerating the models via hard coding.

Although technology in this space has been advancing, there is a significant need for additional methods and tools for use by a typical user that overcome the shortcomings in the current machine learning methodology that require programming expertise, and which produce only limited models due to limited participation by users in the model building process. In particular, there is a desire for multiple users to share their “know-how” derived from these models of how to interpret data in order to benefit from collective improvement of the models, either with colleagues in the same enterprise or at different companies in the same industry. However, given privacy concerns there is also a need to obscure the original training data, so that no confidential or proprietary information is shared between users of this collective model.

### SUMMARY OF THE INVENTION

Accordingly, the present invention is directed to model aggregation tools utilizing model encapsulation of user-directed iterative (UDI) machine learning, and the related methods that offer a typical user, without programming expertise, the ability to create and modify machine learning models. In particular, the present invention further provides methods and tools that not only afford machine learning models that are easily created and configured without the necessity of hard coding by the user, but also to afford multiple users with the ability to share their “know-how” derived from these models to collectively improve the models while maintaining privacy by obscuring the original training data, so that no confidential or proprietary information is shared between users of this collective model. Users may thereby rapidly teach the machine learning models to interpret their data without programming, personalizing the system's analysis and filtering capabilities, and then encapsulate their domain expertise in machine learning models that can be leveraged at scale and shared throughout a single or across multiple enterprises.

As such, one aspect of the present invention provides a model aggregation tool utilizing model encapsulation of user-directed iterative (UDI) machine learning comprising a machine-readable medium having instructions stored thereon for execution by a processor to perform a method of model encapsulation of user-directed iterative machine learning. The method of model encapsulation of user-directed iterative machine learning comprises the steps of establishing user elected search criteria to create a primary machine learning model; training the primary machine learning model with a reference subset based on a comparative scoring analysis to produce a first training data set; validating the first training data set within a database by user direction to create a user-directed machine learning model; training the user-directed machine learning model with a second reference subset based on comparative scoring to produce a second training data set; validating the second training data set within the database by user direction to create a first user-directed iterative machine learning model; and obfuscating the first and second training data sets of the first user-directed iterative machine learning model to create an encapsulated model. This method uses user-directed iterative (UDI) machine learning to create encapsulated models suitable for aggregation with additional training data to form an aggregated user-directed iterative machine learning model.

Another aspect of the present invention provides a method of model encapsulation of user-directed iterative machine learning. This method of model encapsulation comprises the steps of: establishing user elected search criteria to create a primary machine learning model; training the primary machine learning model with a reference subset based on a comparative scoring analysis to produce a first training data set; validating the first training data set within a database by user direction to create a user-directed machine learning model; training the user-directed machine learning model with a second reference subset based on comparative scoring to produce a second training data set; validating the second training data set within the database by user direction to create a first user-directed iterative machine learning model; and obfuscating the first and second training data sets of the first user-directed iterative machine learning model to create an encapsulated model. This method uses user-directed iterative (UDI) machine learning to create encapsulated models suitable for aggregation with additional training data to form an aggregated user-directed iterative machine learning model.

### BRIEF DESCRIPTION OF THE DRAWINGS

Advantages of the present apparatus will be apparent from the following detailed description, which description should be considered in combination with the accompanying drawings, which are not intended limit the scope of the invention in any way.

FIG. 1 is a flow diagram presenting an exemplary method of creating, validating, and modifying machine learning models from the perspective of the inventive system/tool.

FIG. 2 is a flow diagram presenting an exemplary method of creating, validating, and modifying machine learning models from the perspective of a user device.

FIG. 3 is a flow diagram presenting an exemplary method of creating, validating, and modifying machine learning models from the perspective of a third party external to the inventive system/tool and external to a user device.

FIG. 4 illustrates a representative embodiment of the model aggregation system/tool of the present invention, depicting components of the inventive system, and elements external to such components; depicting interrelation of the centralized repository comprising encapsulated models from one user (with obfuscated data) as well as aggregated encapsulated models achieved through the aggregation with a second user.

FIG. 5 illustrates an exemplary embodiment of the graphical user interface for the user-directed iterative (UDI) machine learning of the present invention; depicting the interface for user entry of user elected search criteria.

FIG. 6 illustrates an exemplary embodiment of the graphical user interface for the user-directed iterative (UDI) machine learning of the present invention; depicting the interface, ready for validation, of the first training data set.

FIG. 7 illustrates an exemplary embodiment of the graphical user interface for the user-directed iterative (UDI) machine learning of the present invention; depicting the interface, ready for validation, of the training data sets subsequent to the first training data set (i.e., 2-“n” times). The confidence scores are readily displayed next to each YES/NO validation selector.

FIG. 8 illustrates an exemplary embodiment of the graphical user interface for the user-directed iterative (UDI) machine learning of the present invention; depicting the interface of sample set identified by application of the UDI machine learning model to a database.

FIG. 9 illustrates an exemplary embodiment of the graphical user interface for the user-directed iterative (UDI) machine learning of the present invention; depicting the interface of a particular reference sample classified on a paragraph by paragraph basis, affording user validation of each paragraph.

### DETAILED DESCRIPTION OF THE INVENTION

Given their complexity and requirement for the expertise of a limited segment of society, existing systems and methods of configuring machine learning models (i.e., creating, validating, and modifying machine learning models) have not been successful at helping large numbers of people to configure machine learning models, and who therefore have not been afforded the ability to benefit from the use of machine learning models. Even with advances in this area, the ability to share such machine learning models with others has not been possible, especially considering the needs of industries to keep secure the original training data, so that no confidential or proprietary information would be shared, e.g., to avoid privacy concerns or misuse of the data. To address these shortcomings, and more, the present invention is directed to model aggregation tools utilizing model encapsulation of user-directed iterative (UDI) machine learning, and the related methods that offer a typical user, without programming expertise, the ability to create and modify machine learning models. In particular, the present invention further provides methods and tools that not only afford machine learning models that are easily created and configured without the necessity of hard coding by the user, but also to afford the user with the ability to share their “know-how” derived from these models to collectively improve the models while maintaining privacy by obscuring the original training data, so that no confidential or proprietary information is shared between users of this collective model. Users may thereby rapidly teach the machine learning models to interpret their data without programming, personalizing the system's analysis and filtering capabilities, and then encapsulate their domain expertise in machine learning models that can be leveraged at scale and shared throughout the enterprise.

The present invention allows a user to configure and train a machine learning model, for searches and predictions of certain accessible content, documents, or other materials within a database. The user may further iteratively configure and refine the machine learning model to generate the desired model outcomes, without an understanding of machine learning or expertise in programming. This results, not only in improvements in function, but also cost, and efficiency. Upon development of this machine learning model, the methods and aggregation tools of the present invention afford the ability of the user to encapsulate their domain expertise in machine learning models, obfuscating the training data, which can then be leveraged at scale and shared with other users.

To address this need, the present invention provides novel technology with the following functionality:
1) Allows users to create new user-directed iterative (UDI) machine learning models with new training data for sharing with other members in the “model sharing collective”;
2) Obfuscates the training data so only the learning/interpretation capabilities are shared and not the original training data;
3) Allow users to upload the new user-directed iterative (UDI) machine learning models, with the data obfuscated (i.e., encapsulated models) into a centralized repository for “model sharing”;
4) Allows users to download the shared encapsulated models and validate the results against their own data to approve/reject the updated results to create an aggregated user-directed iterative machine learning model; and
5) Allows users to provide feedback to refine the shared models and improve their capabilities for all members of the model collective by encapsulating the aggregated model and uploading to the model sharing collective, i.e., centralized repository.
   The presently disclosed invention addresses the shortcomings in the current art by presenting methods to create and validate user-configurable and user-modifiable machine learning models, obfuscate the underlying data and share these encapsulated models with others for aggregation. Specifically, in the presently disclosed methods, a user, using a user device, interfaces with the systems/tools described herein to create or modify a machine learning model, obfuscate that model by removing underlying data to encapsulate the model, which allows for sharing and aggregation by other users using other user devices.

Moreover, the present invention provides tools and methods that allow any user to create, configure, validate, and modify any number of machine learning models, and then subsequently obfuscate the underlying data. Generally, the presently-disclosed methods and systems/tools provide for programming and modification of a machine learning model by a user using a user interface, e.g., graphic user interface (GUI). The user-configurable machine learning models disclosed herein may be used for searches of and predictive analytics related to any content, including but not limited to documents, transactions, network-accessible content, or other materials.

The present invention, including model aggregation tools, and related methods will be described with reference to the following definitions that, for convenience, are set forth below. Unless otherwise specified, the below terms used herein are defined as follows:

### I. Definitions

As used herein, the term “a,” “an,” “the” and similar terms used in the context of the present invention (especially in the context of the claims) are to be construed to cover both the singular and plural unless otherwise indicated herein or clearly contradicted by the context.

The term “aggregating” is used herein to describe the combination of an encapsulation model with a training data set through validation. As described herein, such combination is afforded by the encapsulation of user-directed iterative machine learning model, and the validation of that encapsulated model using additional data of a second user database to produce an aggregated user-directed iterative machine learning model.

The term “categorizing” is used herein to describe the process of placing information into quantifiable segments, (e.g. text into discrete filtered paragraphs In certain embodiments of the invention, categorization is a method of organizing the information contained in the database prior to creation of a machine learning model. In certain embodiments, categorization is a method of mapping the user elected search criteria to filter the categorized database. In certain embodiments of the present invention, the categorization is performed on a paragraph by paragraph basis.

The term “classification” is art-recognized, and is used herein to describe a process of identifying results, i.e., matrix results, based on the comparative scoring of a data set in accordance with the mathematical computation of a mathematical construct, e.g., based on syntax (i.e., the arrangement of words and phrases to create well-formed sentences in a language) and nuance (i.e., subtle differences in or shade of meaning, expression, or sound, e.g., relating to context). In particular embodiments, mathematical constructs may be more suited for working with text, sound, images, transactions, or any combination thereof. In certain embodiments of the invention, classification is a method of organizing the information contained in the database as data is applied the mathematical construct of a machine learning model, resulting in a matrix of the data set, e.g., training data set. In certain embodiments of the present invention, the classification is performed on a paragraph by paragraph basis.

The term “collecting” is used herein with respect to data and to describe the act of gathering data, e.g., for use in methods of the present invention. The term “directed” as used herein, for example in the expression “user-directed” is used herein to describe specific active contribution and input by a user, for example, related to user search criteria and validation processing.

The term “encapsulating” or “encapsulation” are used herein to describe models or model systems that have been obfuscated to create a model, i.e., encapsulating the model by capturing the model without the underlying training data. The model is therefore referred to as an encapsulation model.

The term “interface” as used herein, for example in the expression “graphical user interface,” or “GUI” is art-recognized, and describes a shared boundary across which two separate components of a computer system exchange information, which can be between software, computer hardware, peripheral devices, humans and combinations of these. For example, a graphical user interface, or GUI, facilitates the communication/interaction with stored data on a server by a user through the exchange of information or operation in the GUI.

The term “interfacing” is art-recognized, and is used herein to describe the means of communication between two entities, for example a system/tool and user data entry. In certain embodiments, the interfacing may be bi-directional. In other embodiments, the interfacing may be uni-directional. In particular embodiments, such interfacing may be achieved through a graphical user interface.

The term “machine learning model” is art-recognized, and is used herein to describe a system that uses mathematical concepts to construct an algorithm (e.g., neural networks, linear and logistic regression, support-vector machines) that can learn from and make predictions on data. Such algorithms operate by building a model from example inputs, called training data, in order to make data-driven predicted classifications based on probabilistic estimates rather than following strictly static program instructions.

The language “machine-readable medium” is art-recognized, and describes a medium capable of storing data in a format readable by a mechanical device (rather than by a human). Examples of machine-readable media include magnetic media such as magnetic disks, cards, tapes, and drums, punched cards and paper tapes, optical disks, barcodes, magnetic ink characters, and solid state devices such as flash-based, SSD, etc. Machine-readable medium of the present invention are non-transitory, and therefore do not include signals per se, i.e., are directed only to hardware storage medium. Common machine-readable technologies include magnetic recording, processing waveforms, and barcodes. In particular embodiments, the machine-readable device is a solid state device. Optical character recognition (OCR) can be used to enable machines to read information available to humans. Any information retrievable by any form of energy can be machine-readable. Moreover, any data stored on a machine-readable medium may be transferred by streaming over a network. In a particular embodiment, the machine readable medium is a network server disk, e.g., an internet server disk, e.g., a disk array. In specific embodiments, the machine-readable medium is more than one network

The term “obfuscate” or “obfuscating” is used herein to describe the process of stripping or obscuring data from a user-directed iterative machine learning model, e.g., data such as underlying training data. The process of obfuscating ensures that the data used to create the user-directed iterative machine learning model are opaque to the end user of an encapsulated model created by obfuscation of the underlying data. In particular, only the learning/interpretation capabilities of the model are accessible to the users that have not contributed the data. In specific embodiments, the obfuscation is the result of the production of a non-human readable model format constructed from mathematical weights based on training data sets.

The term “storing” is art-recognized, and is used herein to describe the act of saving data on a machine readable medium in a manner that such data is subsequently retrievable on that machine readable medium.

The term “multi-tenant” is art recognized, and is used to describe software architecture in which a single instance of software runs on a server and serves multiple tenants. A tenant (or customer) is a group of users who share a common access with specific privileges to the software instance.

The term “user” is used herein to describe any person that interfaces with the methods or tools of the present invention. In certain embodiments, such users may include those users who enter the information into the tools of the invention, or those that view the data. Such user, in certain embodiments, interacts with the interfaces described herein through electronic means, e.g., computer or mobile device.

The language “user interface” is used herein to describe the graphical user interface (GUI), e.g., which allows the user to interface with the application programming interface (API), and enter data using interface components such as buttons, text fields, check boxes, etc.

The term “validating” is the process a user uses to review, confirm, or deny the predicted outcomes of a machine learning model; modification of which serves to train the model, i.e., serving the function of checking or proving, and then improving the validity or accuracy of the model through this process of review, or validation. In particular embodiments, iterative user validation of machine learning models in the present invention are achieved through confirmation of the scoring model output training data set (e.g., positive and/or negative) for relevance to the user's desired results, and offering the user an option to further modify the validated machine learning model via modifying or adding the training data.

### II. Methods of Model Encapsulation of User-Directed Iterative Machine Learning

The present invention provides methods of model encapsulation of user-directed iterative machine learning such that machine learning models may be created, validated, modified, and applied without the user writing or editing the programming that underlies the machine learning models, and then subsequently the machine learning model is obfuscated in order to strip any training data from a user-directed iterative machine learning model. In particular, the methods utilize an iterative process of input and selections, e.g., from a user interface, wherein the user may direct the machine learning by both electing the search criteria, as well as modification of the machine learning model (“MLM”) through iterative user validation of the model. The output from the machine learning models as applied to a database may be accepted, transmitted, or feedback received, e.g., from a user interface, may be used by the methods and tools herein to further validate and/or modify the machine learning models, i.e., iteratively. Encapsulation of these models achieved by obfuscating the underlying training data affords the ability to share the models derived from user-directed iterative machine learning with others through a centralized database/repository, without sharing the underlying data.

Moreover, the user-directed iterative machine learning of the present invention provides unprecedented integration of user direction in the establishment and modification of the machine learning models of the present invention, which upon encapsulation may be shared within a model sharing collective created to aggregate models contributing to the potential for exponential improvements in machine learning modelling, e.g., industry dependent, e.g., fraud/regulatory review, oversight and detection. In this way, the methods of the present invention facilitate direct user input into the election of search criteria, iterative user validation of machine learning models through confirmation of the scoring model output training data set (e.g., positive and/or negative) for relevance to the user's desired results, and offering the user an option to further modify the validated machine learning model; wherein such modeling may be encapsulated and shared for aggregation with other user-directed iterative machine learning.

As such, one embodiment of the present invention provides a method of model encapsulation of user-directed iterative machine learning comprising the steps of:
establishing user elected search criteria to create a primary machine learning model;
training the primary machine learning model with a reference subset based on a comparative scoring analysis to produce a first training data set;
validating the first training data set within a database by user direction to create a user-directed machine learning model;
training the user-directed machine learning model with a second reference subset based on comparative scoring to produce a second training data set;
validating the second training data set within the database by user direction to create a first user-directed iterative machine learning model; and
obfuscating the first and second training data sets of the first user-directed iterative machine learning model to create an encapsulated model,
   such that the user-directed iterative (UDI) machine learning is used to create encapsulated models suitable for aggregation with additional training data to form an aggregated user-directed iterative machine learning model.

In certain embodiments of the present invention, the method of model encapsulation of user-directed iterative machine learning further comprises the step of uploading the encapsulated model into a centralized repository useful for sharing encapsulated models.

In certain embodiments of the present invention, the method of model encapsulation of user-directed iterative machine learning further comprises the step of downloading the encapsulated model and applying said encapsulated model to a second database of a second user, wherein a second results data set is established for the second database, e.g., based on the second user search criteria.

In certain embodiments of the present invention, the method of model encapsulation of user-directed iterative machine learning further comprises the step of downloading the encapsulated model and aggregation of the encapsulation model with a third training data set within a second database of a second user by user direction of a second user to create an aggregated user-directed iterative machine learning model. In certain embodiments, the validation is preceded by training the encapsulated machine learning model with a reference subset based on a comparative scoring analysis to produce the third training data set.

In certain embodiments of the present invention, the method of model encapsulation of user-directed iterative machine learning further comprises the step of obfuscating the third training data set of the aggregated user-directed iterative machine learning model to create an aggregated encapsulated model, wherein such aggregated encapsulated model is suitable for aggregation with additional training data to form a second aggregated user-directed iterative machine learning model.

In certain embodiments of the present invention, the method of model encapsulation of user-directed iterative machine learning further comprises the step of uploading the aggregated encapsulated model into a second centralized repository useful for sharing aggregated encapsulated models, e.g., the first and second centralized repositories are the same. In certain embodiments, the aggregated encapsulated model replaces a prior encapsulated model, e.g., aggregated encapsulated model. In a particular embodiment, users are afforded the ability to provide feedback to refine the shared models and improve their capabilities for all members of the model collective, i.e., users that have access to the centralized repository. In certain alternative embodiments, the aggregated encapsulated model adds an additional encapsulated model to the centralized repository.

In certain embodiments of the present invention, the method of model encapsulation of user-directed iterative machine learning further comprises the step of providing an interface for the second user to access the centralized repository.

In certain embodiments of the present invention, the method of model encapsulation of user-directed iterative machine learning further comprises the step of providing an interface for the second user to apply or validate an encapsulated model using a data set.

In certain embodiments of the present invention, method of model encapsulation is designed for use in detection or prevention of fraud, risk analysis, or compliance, e.g., regulatory or customer service.

The user-directed iterative machine learning of the present invention may comprise additional training and validation steps as described herein, and which serve as additional iterations of user-direction, e.g., to the nth degree. In fact, the user-directed iterative machine learning of the present invention may be iterated until the user is satisfied that a machine learning model of the present invention is created that meets the criteria the user desired to achieve, and which is generating useful and relevant results. Because this process is simplified, accelerated, and reduced in cost relative to the known machine learning methods, and because a model can be duplicated, the inventive methods and systems can be used to create and modify a plurality of machine learning models. This addresses well-known problems in current machine learning, wherein users typically will have created a very limited number of machine learning models on their behalf, because of the time and expense required to construct and validate each such model. This also improves the current abilities to utilize machine learning, by facilitating easier and user-driven modification of machine learning models, without requiring hiring programmers to modify the code that created and runs the machine learning model. Accordingly, in certain embodiments of the present invention, the method of model encapsulation of user-directed iterative machine learning comprises the step of further training the first user-directed machine learning model with one or more additional reference subsets based on comparative scoring to produce additional training data sets; validating the additional training data sets by user direction to create a modified user-directed iterative machine learning model; and obfuscating said modified user-directed iterative machine learning model.

In certain embodiments of the present invention, the method of model encapsulation of user-directed iterative machine learning comprises the step of modification (e.g., addition, subtraction, or editing) of the user search criteria, e.g., within the user-directed iterative machine learning model. Such modification may be made at any time, including, for example, before or after any step, or subsequent to establishing any results data set based on any user search criteria and user-directed iterative machine learning.

In certain embodiments of the present invention, the method of model encapsulation of user-directed iterative machine learning further comprises the step of database categorization, e.g., based on textual analysis.

In certain embodiments of the methods of the present invention, the database is categorized by subparts, e.g., paragraph by paragraph of textual documents.

In certain embodiments of the methods of the present invention, the database comprises source content selected from the group consisting of consumer content, business content, news content, education content, and scientific content. In particular embodiments, the source may be the news, earnings reports, management discussions, company profiles, people biographies, transaction records (e.g., logs and transcripts of meetings), customer service, meeting documentation, or any combination thereof.

In certain embodiments of the methods of the present invention, the training set data and results data set identify content on a paragraph by paragraph basis, e.g., contained in a complete textual document.

In certain embodiments of the present invention, the method of model encapsulation of user-directed iterative machine learning further comprises the step of providing an interface for the user to establish the user search criteria, e.g., via request within the interface.

In certain embodiments of the present invention, the method of model encapsulation of user-directed iterative machine learning further comprises the step of a user interfacing with a user interface, e.g., on a device.

In certain embodiments of present invention, the systems/tools that carry out the methods disclosed herein comprise one or more central computing devices, one or more memory units, one or more input and output channels for communication, one or more databases, one or more networks which may be solely internal and may include the Internet, optionally one or more displays, and the ability to communicate with one or more user devices, including receiving information from such user devices and sending information to such user devices. The interactions of the system/tool components with each other and with a plurality of user devices, and the ways in which the system components carry out the methods of the present invention, are described herein in greater detail. In particular embodiments, however, the system/tools of the invention utilize a combination of cloud and local devices.

A. Establishing User Elected Search Criteria

The methods of user-directed iterative (UDI) machine learning of the present invention afford a user the ability to select, customize, or specifically individualize the search criteria based on attributes of the training data, e.g., the user-selected set of pre-processing parameters. In certain embodiments, the user elected search criteria is selected from the group consisting of keywords (e.g., including or excluding certain keywords), source content (e.g., company profiles), confidence threshold, and number of desired occurrences (e.g., number of sample paragraphs returned in a paragraph by paragraph analysis). In particular embodiments, the user selects a set of source training data and a set of pre-processing parameters (i.e., as identified by the user elected search criteria), and the pre-processing parameters are used to convert the set of training data to a set of mathematical matrices suitable for building a machine learning model, i.e., the primary machine learning model.

The establishment of the user elected search criteria is used to create a primary machine learning model. In certain embodiments, the user elected search criteria is established by the act of requesting search criteria entry from a user, e.g., defining pre-processing parameters.

In certain embodiments of the present invention, the method of user-directed iterative (UDI) machine learning further comprises the step of categorizing the user search criteria.

Thereafter, the novel and inventive methods of the present invention train the primary machine learning model utilizing a reference subset, e.g., of a database, which is referred to as training data.

B. Training the Primary Machine Learning Model

The primary machine learning model is trained, or presented, with one or more sets of training data from a database (e.g., subset of a database), which can come from any source (e.g., being provided by the system/tool, by the user, or searched for), and described herein as a reference subset. The model processes the reference subset based on a comparative scoring analysis, e.g., calculating probability accuracy of the predictions of the application of the model to a given set of data, e.g., via classification. In certain embodiments, this scoring analysis provides both positive and negative comparisons. In particular embodiments, the comparative scoring analysis is based on textual scoring, e.g., derived from a machine learning based toolkit for natural language processing (e.g., tokenization, sentence segmentation, part-of-speech tagging, named entity extraction, chunking, parsing, and co-reference resolution).

The product of processing the reference subset within the model is a first training data set, e.g., along with the probability of the accuracy of the predictions based on the model. Thereafter, the novel and inventive methods of the present invention validate the primary machine learning model by consideration of the actual relevancy of the first training data set through direct user input.

C. Validating the First Training Data Set

Validating the first training data set within the database is achieved by user direction on which item members of the first training data set accurately fall within the desired results of the machine learning model, e.g., with respect to the indication of a positive or a negative result. Such user direction may be established by particular rejection or confirmation of the accuracy of the prediction made by the model to establish a given member of the first training data set.

The process of validation of primary machine learning model creates a user-directed machine learning model. As described herein, this validation process may be iteratively applied to the training set data or the result of the UDI machine learning models of the present invention.

D. Training of the User-Directed Machine Learning Model

In iterative fashion, the user-directed machine learning model is trained with a separate set of training data from a database (e.g., a second subset of the database, e.g., non-overlapping; or a separate database), which can come from any source (e.g., being provided by the system/tool, by the user, or searched for). This separate set of training data is referred to herein as a second reference subset.

The user-directed machine learning model processes the second reference subset based on a comparative scoring analysis to produce a second training data set, e.g., along with the probability of the accuracy of the predictions based on the model, e.g., via classification. In certain embodiments, this scoring analysis provides both positive and negative comparisons. In particular embodiments, the comparative scoring analysis is based on textual scoring.

Thereafter, the novel and inventive methods of the present invention validate the user-directed machine learning model by consideration of the actual relevancy of the second training data set through direct user input.

E. Validating the Second Training Data Set

Validating the second training data set within the database is achieved by user direction on which item members of the second training data set accurately fall within the desired results of the machine learning model, e.g., with respect to the indication of a positive or a negative result. Such user direction may be established by particular rejection or confirmation of accuracy of the prediction made by the model to establish a given member of the second training data set.

The process of validation of the second training data set of the user-directed machine learning model affords the creation of a user-directed iterative machine learning model. As described herein, this validation process may be repeatedly utilized on subsequent training data sets (e.g., third, fourth, or nth training data sets) generated by processing a subsequent reference subset (e.g., third, fourth, or nth reference subset from the database), and based on a comparative scoring analysis described herein, until the user is satisfied with the accuracy of the results. Once satisfied with the results, the user may apply the resultant user-directed iterative machine learning model to the database at large.

F. Obfuscating Said User-Directed Iterative Machine Learning Model

Once the user-directed iterative machine learning model is created it is then obfuscated by stripping or obscuring the first and second training data sets of the first user-directed iterative machine learning model to create an encapsulated model suitable for aggregation with additional training data to form an aggregated user-directed iterative machine learning model. Obscuring the original training data affords an encapsulated model that contains no confidential or proprietary information.

Such encapsulated model may be shared to a centralized repository for other users to apply or validate/aggregate with their own user direction and training data. In this way, aggregation of the encapsulated model with the additional training data is achieved, which may in turn, be encapsulated, and shared to a centralized repository for use and/or aggregation with other users data.

### III. Tools of the Invention for Model Aggregation

The methods of the present invention described herein are useful as instructions stored on a machine-readable medium for execution by a processor to perform the method. In certain embodiments, the methods and tools of the present invention also make use and/or comprise a processor. Accordingly, any methods of the present invention, alone or in combination with other methods (such as those described herein or elsewhere) may be stored on a machine-readable medium for execution by a processor to perform the method. Such a composition comprises a model aggregation tool of the invention utilizing model encapsulation of user-directed iterative (UDI) machine learning. Moreover, in certain embodiments of the invention, the methods of the present invention may be implemented as a mobile-capable application or as a laptop-, server- or workstation-implemented application that allows a user to create a machine learning model “on the fly”, that is, to refine it iteratively through use and validation of the model, and subsequently encapsulate the model by obfuscating the underlying training data.

Accordingly, another embodiment of the present invention provides a model aggregation tool utilizing model encapsulation of user-directed iterative (UDI) machine learning comprising a machine-readable medium having instructions stored thereon for execution by a processor to perform a method of model encapsulation of user-directed iterative machine learning. In certain embodiments of the present invention, the present invention provides a model aggregation tool utilizing model encapsulation of user-directed iterative (UDI) machine learning comprising a machine-readable medium having instructions stored thereon for execution by a processor to perform a method of model encapsulation of user-directed iterative machine learning comprising the steps of
establishing user elected search criteria to create a primary machine learning model;
training the primary machine learning model with a reference subset based on a comparative scoring analysis to produce a first training data set;
validating the first training data set within a database by user direction to create a user-directed machine learning model;
training the user-directed machine learning model with a second reference subset based on comparative scoring to produce a second training data set;
validating the second training data set within the database by user direction to create a first user-directed iterative machine learning model; and
obfuscating the first and second training data sets of the first user-directed iterative machine learning model to create an encapsulated model,
   such that the user-directed iterative (UDI) machine learning is used to create encapsulated models suitable for aggregation with additional training data to form an aggregated user-directed iterative machine learning model.

In certain embodiments of the model aggregation tool of the present invention, the method of model encapsulation further comprises the step of uploading the encapsulated model into a centralized repository useful for sharing encapsulated models.

In certain embodiments of the model aggregation tool of the present invention, the method of model encapsulation further comprises the step of downloading the encapsulated model and applying said encapsulated model to a second database of a second user, wherein a second results data set is established for the second database, e.g., based on the second user search criteria.

In certain embodiments of the model aggregation tool of the present invention, the method of model encapsulation further comprises the step of downloading the encapsulated model and aggregation of the encapsulation model with a third training data set within a second database of a second user by user direction of a second user to create an aggregated user-directed iterative machine learning model. In certain embodiments, the validation is preceded by training the encapsulated machine learning model with a reference subset based on a comparative scoring analysis to produce the third training data set.

In certain embodiments of the model aggregation tool of the present invention, the method of model encapsulation further comprises the step of obfuscating the third training data set of the aggregated user-directed iterative machine learning model to create an aggregated encapsulated model, wherein such aggregated encapsulated model is suitable for aggregation with additional training data to form a second aggregated user-directed iterative machine learning model.

In certain embodiments of the model aggregation tool of the present invention, the method of model encapsulation further comprises the step of uploading the aggregated encapsulated model into a second centralized repository useful for sharing aggregated encapsulated models, e.g., the first and second centralized repositories are the same. In certain embodiments, the aggregated encapsulated model replaces a prior encapsulated model, e.g., aggregated encapsulated model. In a particular embodiment, users are afforded the ability to provide feedback to refine the shared models and improve their capabilities for all members of the model collective, i.e., users that have access to the centralized repository. In certain alternative embodiments, the aggregated encapsulated model adds an additional encapsulated model to the centralized repository.

In certain embodiments of the model aggregation tool of the present invention, the method of model encapsulation further comprises the step of providing an interface for the second user to access the centralized repository.

In certain embodiments of the model aggregation tool of the present invention, the method of model encapsulation further comprises the step of providing an interface for the second user to apply or validate an encapsulated model using a data set.

In certain embodiments of the model aggregation tool of the present invention, the tool is designed for use in detection or prevention of fraud, risk analysis, or compliance, e.g., fraudulent credit reports. In particular embodiments, multiple users, e.g., departments or other collaborators, are able to share collective “know-how” for fraud prevention/detection, risk analysis and compliance using encapsulation and aggregation of models, as described herein. Specifically, given the encapsulation utilizing obfuscation, each institution's confidential data within their organization is obscured and the resulting encapsulated model shares only the “know-how” for analyzing data, e.g., for potential fraud.

In certain embodiments of the model aggregation tool of the present invention, the tool may be used to identify items, lists, classes, and even subclasses of content for importation into existing databases of information, for example, risks associated with current customers or synthetic credit identities based on credit report databases, e.g., fraud detection (e.g., of commonly recurring fraudulent patterns), etc. Such embodiments would be useful for automating fraud detection workflows, e.g., common across multiple departments or collaborative users, e.g., for government regulated reporting.

In certain embodiments of the model aggregation tool of the present invention, the method of model encapsulation further comprises the step of further training the first user-directed machine learning model with one or more additional reference subsets based on comparative scoring to produce additional training data sets; validating the additional training data sets by user direction to create a modified user-directed iterative machine learning model; and obfuscating said modified user-directed iterative machine learning model. In certain embodiments of the model aggregation tool of the present invention, the method of model encapsulation comprises the step of modification (e.g., addition, subtraction, or editing) of the user search criteria, e.g., within the user-directed iterative machine learning model. Such modification may be made at any time, including, for example, before or after any step, or subsequent to establishing any results data set based on any user search criteria and user-directed iterative machine learning.

In certain embodiments of the model aggregation tool of the present invention, the user elected search criteria is selected from the group consisting of keywords (e.g., including or excluding certain keywords), source content (e.g., company profiles output), confidence threshold, and number of desired occurrences (e.g., number of sample paragraphs returned in a paragraph by paragraph analysis).

In certain embodiments of the model aggregation tool of the present invention, the method of model encapsulation further comprises the step of providing an interface for the user to establish the user search criteria, e.g., via request within the interface.

In certain embodiments of the model aggregation tool of the present invention, the method of model encapsulation further comprises the step of a user interfacing with a user interface, e.g., on a device.

In certain embodiments of the model aggregation tool of the present invention, the user elected search criteria is established by the act of requesting search criteria entry from a user, e.g., defining pre-processing parameters.

In certain embodiments of the model aggregation tool of the present invention, the method of model encapsulation further comprises the step of categorizing the user search criteria.

In certain embodiments of the model aggregation tool of the present invention, the method of model encapsulation further comprises the step of database categorization, e.g., based on textual analysis. In particular embodiments, the database and the database categorization, e.g., categorization information or organization format of the database, are collected and stored on a machine readable medium, e.g., a server or collection of servers.

In certain embodiments of the model aggregation tool of the present invention, the database is categorized by subparts, e.g., paragraph by paragraph.

In certain embodiments of the model aggregation tool of the present invention, the database comprises source content selected from the group consisting of consumer content, business content, news content, education content, and scientific content. In particular embodiments, the source may be the news, earnings reports, management discussions, company profiles, people biographies, transaction records (e.g., logs and transcripts of meetings), customer service, meeting documentation, or any combination thereof.

In certain embodiments of the model aggregation tool of the present invention, the training set data and results data set identify content on a paragraph by paragraph basis.

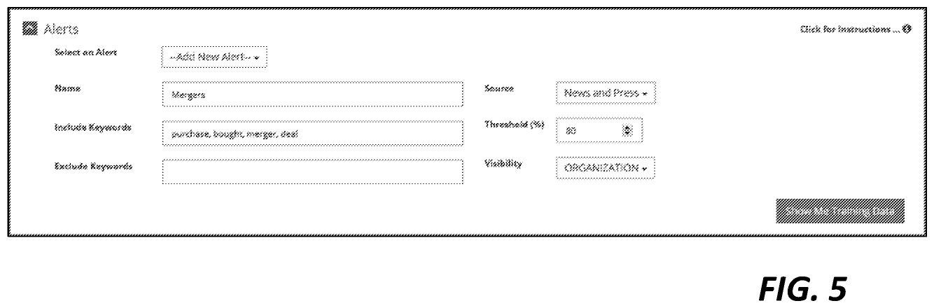

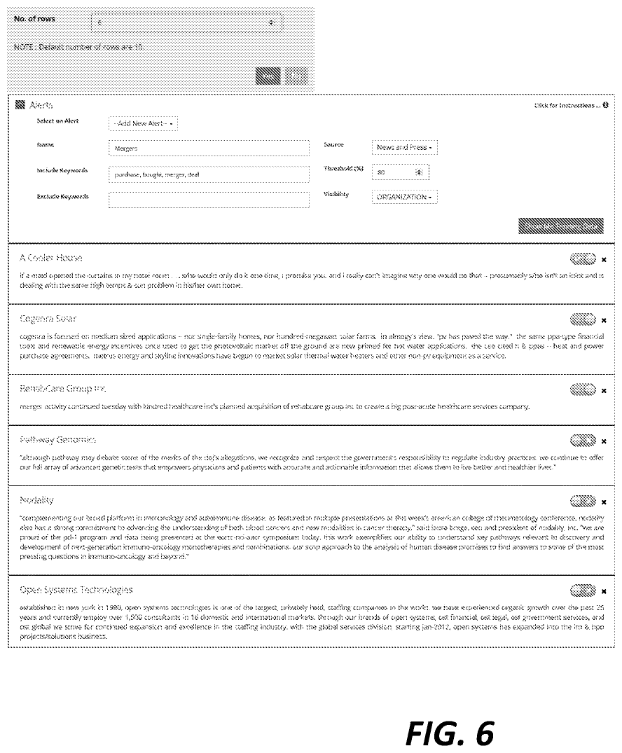

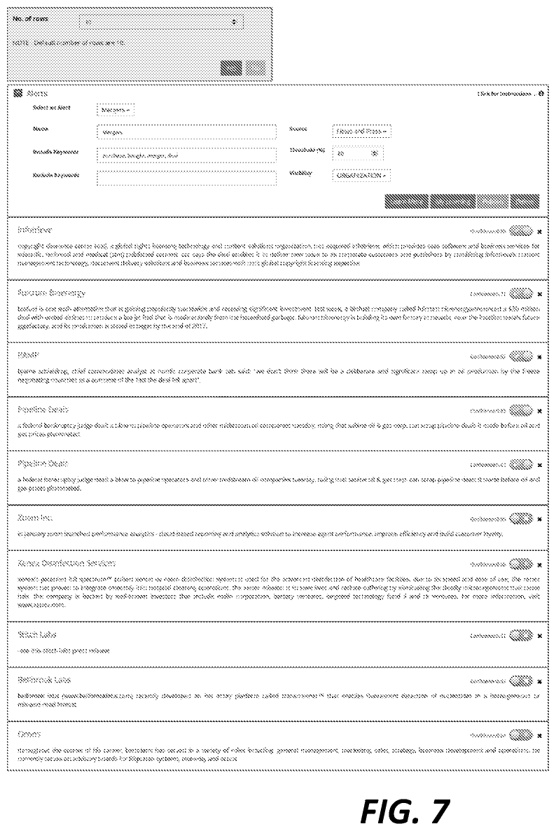

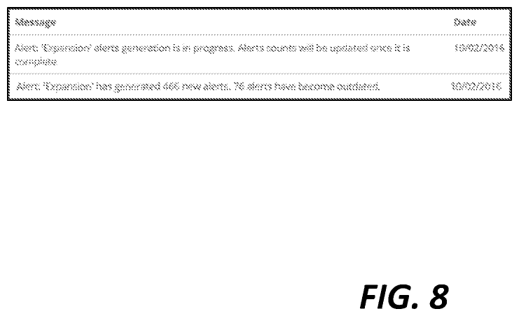

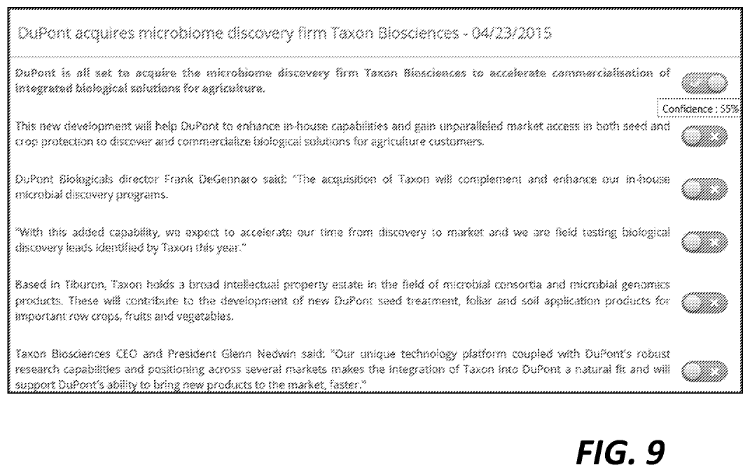

In certain embodiments of the model aggregation tool of the present invention, the method of model encapsulation further comprises the step of a user interfacing with a user interface, e.g., on a device. In particular embodiments, a graphical user interface affords a useful way to implement the methods of the invention, for example, as depicted in FIGS. 5 to 9.

In certain embodiments of the model aggregation tool of the present invention, a user may duplicate and/or modify a machine learning model of the present invention. In certain embodiments, the tool stores each user's personal model for their own individual use, e.g., on a server/database. In particular embodiments, the model storage is tenant based, i.e., in a multi-tenant environment.

In certain embodiments of the model aggregation tool of the present invention, the method of model encapsulation further comprises one or more steps for imposing security restrictions on access to the tools of the present invention, e.g., requiring secure authentication.

In certain embodiments of the model aggregation tool of the present invention, the tool provides a multi-tenant environment.

In certain embodiments of the model aggregation tool of the present invention, the machine-readable medium is online software or offline software. In a particular embodiment, the software is an online application. In particular embodiments, the software is a web-based application. In an alternative particular embodiment, the software is a cloud-based application. In an alternative particular embodiment, the software is an offline application. Moreover, the tool may be a web application accessible in an Internet browser, a desktop software running on Windows, Mac OS, Linux (or any other operating system), or a mobile application (available on smartphones or tablets). In particular embodiments, however, the system/tools of the invention utilize a combination of cloud and local devices.

In certain embodiments of the model aggregation tool of the present invention, the machine-readable medium is selected from the group consisting of magnetic media, punched cards, paper tapes, optical disks, barcodes, magnetic ink characters, and solid state devices. In particular embodiments, the machine-readable medium is selected from the group consisting of magnetic media, optical disks, and solid state devices.

A. Additional Particular Embodiments

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device may comprise or consist of a general-purpose computing device in the form of a computer including a processing unit, a system memory, and a system bus that couples various system components including the system memory to the processing unit. Computers typically include a variety of computer-readable media, i.e., machine-readable media, which can form part of the system memory and be read by the processing unit. By way of example, and not intended to limit in any way, computer-readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Android operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, REXX, Scala, and/or JavaScript for example. In particular embodiments, the programming language used may include assembly language, Basic, C, C++, C#, FORTRAN, Java, Prolog, Python, Scala, and/or JavaScript. Further, it is not necessary that a single type of instruction or programming language be utilized in conjunction with the operation of the system and method of the invention. Rather, any number of different programming technologies may be utilized as is necessary or desirable to achieve the intended function; including, for example, programming providing cloud-based fast parallel execution, such as Apache Spark or Ignite.

The present invention utilizes machine learning model libraries in the creation of the primary machine learning model of the present invention; which are ultimately used to create the user-directed iterative machine learning model of the present invention. Such machine learning model libraries serve as the mathematical construct for conversion of data into one or more matrices of data, e.g., suitable for application to text (e.g., natural language), images, or sound. In particular embodiments, such standard machine learning libraries may include Stanford NLP (e.g. for text analysis), Google's TensorFlow, OpenCV by NVIDIA (e.g., for computer vision image recognition), and Accord.net (e.g., for computer vision and digital audio analysis).

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

### IV. Design Aspects of the Invention

Independent of the utility related to user-directed iterative machine learning tools of the present invention, the ornamental appearance of any novel design provided herein is intended to be part of this invention, for example, where, in certain embodiments the software/application will have a look and feel, which may form an independent or combined ornamental appearance of user-directed iterative machine learning tools described herein.

Accordingly, one embodiment of the present invention provides an ornamental design for a user-directed iterative machine learning tools as shown and described.

### EXEMPLIFICATION

Having thus described the invention in general terms, reference will now be made to the accompanying drawings of exemplary embodiments, which are not necessarily drawn to scale, and which are not intended to be limiting in any way.

In this respect, it is to be understood that the invention is not limited in its application to the details of construction and to the arrangements of the components set forth in the following description or illustrated in the Figures. The invention is capable of other embodiments and of being practiced and carried out in various ways. Also, it is to be understood that the phraseology and terminology employed herein are for the purpose of description and should not be regarded as limiting.

### Example 1

### User-Directed Iterative Machine Learning

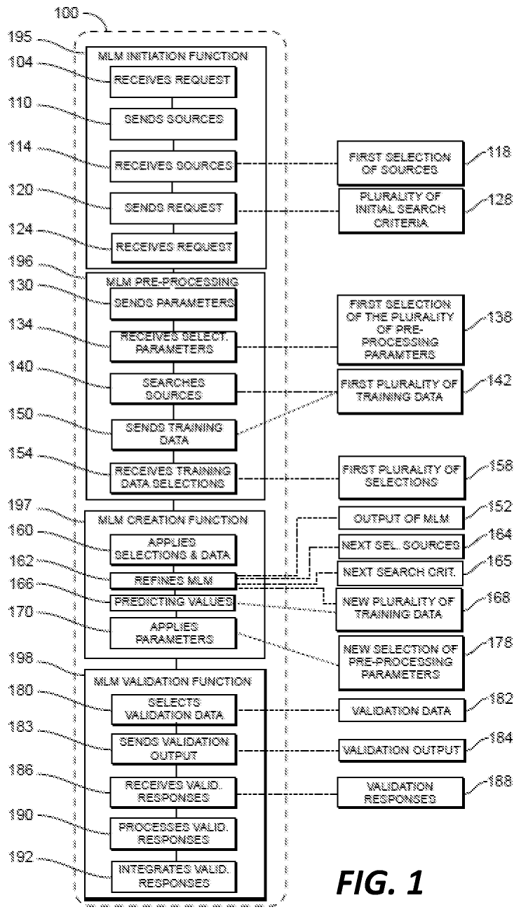

With reference to FIG. 1, in one particular embodiment of the invention, and presenting the inventive methods 100 from the perspective of the system 400, it has been found advantageous to have the present invention comprise the following steps. A system 400 first carries out a MLM initiation function 195, which may be processed utilizing a MLM initiation module 452. The system 400 receives 104 a request from a user device 410 for a new MLM. The system 400 then sends 110 a first plurality of sources to the user device 410. The system 400 receives 114 a first selection of sources 118 from the user device 410. The system 400 thereafter sends 120 a request to the user device 410 for a plurality of initial search criteria 128. Later, the system 400 receives 124 the plurality of initial search criteria 128.

The system 400 thereafter carries out a MLM pre-processing function 196, which may be processed utilizing a MLM pre-processing module 454. The system 400 sends 130 a plurality of pre-processing parameters to the user device 410. The plurality of pre-processing parameters may comprise the data sources, specifically the first selection of sources 118; a level of specificity with which the data of the first selection of sources 118 is to be searched; a confidence threshold; a plurality of guideline keywords to filter the initial set of training data; and more. Thereafter, the system 400 receives 134 from the user device 410 a first selection of the plurality of pre-processing parameters 138. Later, the system 400 searches 140 the plurality of databases 470 or other locations, including but not limited to sources accessible via the network 420, containing or comprising the first selection of sources 118 for the plurality of initial search criteria 128. The results of this search 140 comprise the first plurality of training data 142. The inventive system also adds deliberate non-matches from the results of the search 140 to the first plurality of training data 142, so that the first plurality of training data 142 further comprise such deliberate non-matches, which are effectively controls in validating the machine learning model, so that the user may choose some of the first plurality of training data 142 as non-relevant results.

The system 400 then sends 150 the first plurality of training data 142 to the user device 410. Each of the plurality of results comprising the first plurality of training data 142 for the MLM is sent 150 to the user device 410 with a plurality of selectors, e.g., checkboxes, which the user device 410 may use to collect input on the relevance or utility of each such result.

In certain embodiments, it has been found advantageous to have the system 400 send 150 to the user device 410 confidence interval scores related to each such result comprising the first plurality of training data 142 of the MLM. The system 400 may also send 150 to the user device 410 metadata accompanying each such result. Later, the system 400 receives 154 from the user device 410 a first plurality of selections 158 of the first plurality of training data 142, and advantageously, also the user's feedback on the relevance of each of the first plurality of training selections 158, such feedback being necessary for the MLM creation function 197.

The system 400 thereafter carries out a MLM creation function 197, which may be processed utilizing a MLM creation module 456. The system 400 applies 160 the first plurality of selections 158 of the first plurality of training data 142, including but not limited to the user's feedback on which results are accurate, relevant, or desired, and which are not accurate, relevant, or desired, to the first selection of the plurality of pre-processing parameters 138 to create the initial MLM.

In certain embodiments, it has been found advantageous to have the system 400, at a later time, refine 162 the MLM by i) iterating the step of searching 140, in the plurality of databases 470 or other sources of data containing or comprising the first selection of sources 118 or a next selection of sources 164, for the plurality of initial search criteria 128, and/or for a next plurality of search criteria 165, such iterated search 140 resulting in a new plurality of training data 168, and then ii) predicting 166 the outcome values for the new plurality of training data 168 based on the MLM. The user later validates the outcomes values from the new plurality of training data 168, in steps described below as the MLM validation function 198, with the feedback received from the user device 410 appended to the then-existing training data in the system 400, resulting in modification of the MLM.

In another embodiment of the present invention, the system 400 may refine 162 the MLM by iterating a plurality of the MLM pre-processing function 196, that is, the MLM may iterate a plurality of steps 130, 134, 140, 150, and/or 154, to i) obtain a next plurality of processing parameters, and/or ii) search for a next set of search criteria, and/or iii) send an output 152 of the MLM to the user device 410, and iv) receive feedback from the user device 410 as a new plurality of training data 168.

In some embodiments of the present invention, after refining 162 the MLM, the system 400 may apply 170 a new selection of pre-processing parameters 178 to modify the MLM, including but not limited to changing the confidence interval or guideline keywords. The new selection of pre-processing parameters 178 may be generated by iterating the relevant steps of the above-disclosed methods (sending 130 a plurality of pre-processing parameters to the user device 410, and receiving 134 from the user device 410 the new selection of pre-processing parameters 178), or the new selection of pre-processing parameters 178 may comprise a subset of the first selection of the plurality of pre-processing parameters 138, optionally combined with additional pre-processing parameters.

In certain embodiments, it has been found advantageous to have the method 100 further comprise a MLM validation function 198, which may be processed utilizing a MLM validation module 458. The system 400 selects 180 a plurality of validation data 182 and runs the MLM to process the plurality of validation data 182 to generate a validation output 184. The system 400 then sends 183 the validation output 184 to the user device 410, and the system 400 thereafter receives 186 from the user device 410 a plurality of validation responses 188 from a user regarding the accuracy of the validation output 184. The system 400 processes 190 the plurality of validation responses 188, and integrates 192 the plurality of validation responses 188 to the MLM, modifying the MLM to improve accuracy and relevance of model output 152 to meet the needs or interests of that user. This MLM validation function 198 may be iterated by the user until satisfied with the accuracy and relevance of the model output 152, or as many times as the user wishes to iterate. The inventive methods allow a user, using a user device 410, to revisit any feedback the user has given on any previous training data or model output 152, whether entered during the MLM pre-processing function 196, the MLM creation function 197, or the MLM validation function 198, whether the feedback was given during the first time any such function was processed, or during an iteration of any such function. Revisiting any feedback will cause the system 400 to refine 162 the MLM.

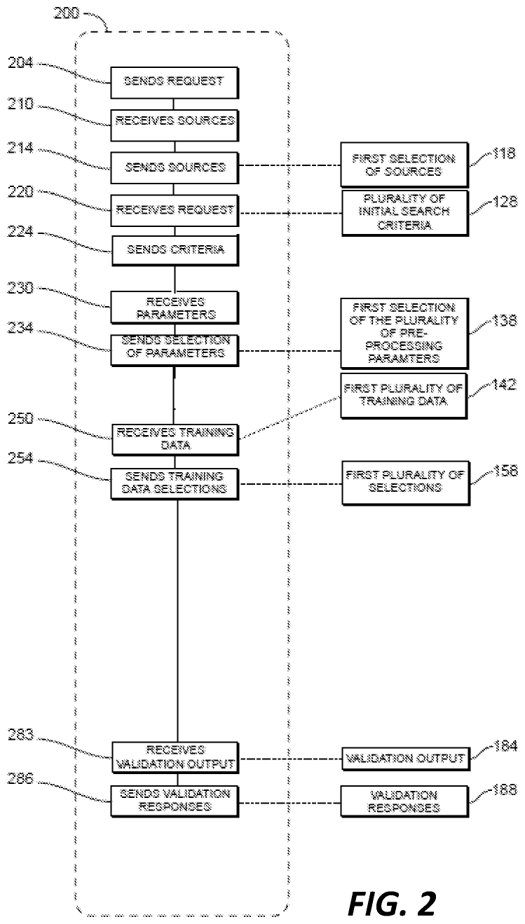

With reference to FIG. 2, in one particular embodiment of the invention, and presenting the inventive methods 200 from the perspective of a user device 410, it has been found advantageous to have the present invention comprise the following steps. The user device 410 sends 204 a request to the system 400 for a new machine learning model. The user device 410 later receives 210 a first plurality of sources from the system 400. The user device 410 sends 214 a first selection of sources 118 to the system 400. The user device 410 thereafter receives 220 a request from the system 400 for a plurality of initial search criteria 128. Later, the user device 410 sends 224 the plurality of initial search criteria 128 to the system 400.

The user device 410 receives 230 a plurality of pre-processing parameters from the system 400. Thereafter, the user device 410 sends 234 to the system 400 a first selection of the plurality of pre-processing parameters 138. The user device 410 later receives 250 a first plurality of training data 142 from the system 400, along with a plurality of selectors, e.g., checkboxes, which the user device 410 may use to collect input on the relevance or utility of each result in the first plurality of training data 142, and/or confidence interval scores or metadata. Later, the user device 410 sends 254 to the system 400 the first plurality of selections 158 of the first plurality of training data 142.

In some embodiments of the present invention, the user device 410 may iterate the steps of receiving 230 and sending 234, to send a next plurality of processing parameters, and/or receiving 150 and sending 154, to send feedback on a new plurality of training data 168.

Thereafter, the user device 410 receives 283 the validation output 184 from the system 400, and the user device 410 later sends 286 to the system 400 the plurality of validation responses 188 from a user regarding the accuracy of the validation output 184. These steps, of receiving 283 and sending 286, may be iterated by the user until satisfied with the accuracy and relevance of the model output 152, or as many times as the user wishes to iterate. The inventive methods allow a user, using a user device 410, to revisit any feedback the user has given on any previous training data or model output 152.

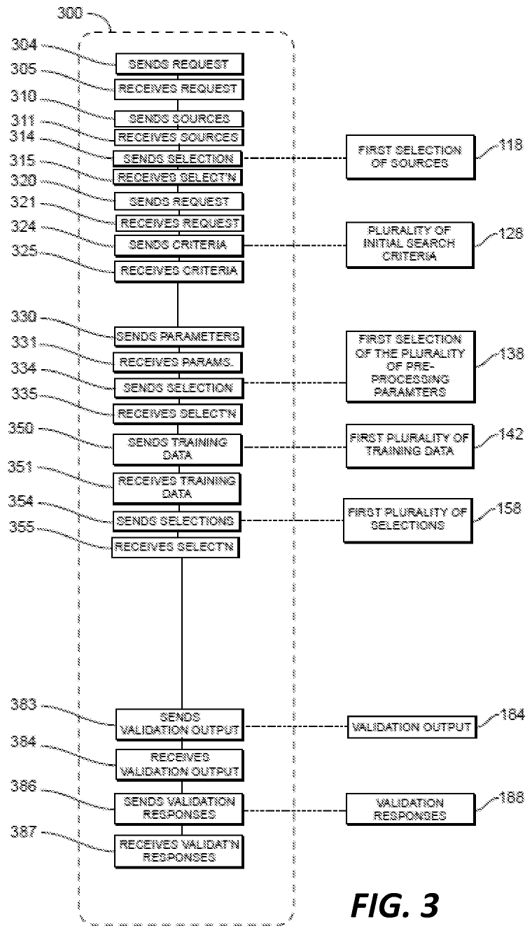

With reference to FIG. 3, in one particular embodiment of the invention, and the methods 300 from the perspective of a third party external to both the system 400 and the user device 410, it has been found advantageous to have the present invention comprise the following steps. The user device 410 sends 304 a request to the system 400 for a new machine learning model, and the system receives 305 the request. The system 400 later sends 310 the first plurality of sources, and the user device 410 receives 311 the first plurality of sources. The user device 410 sends 314 a first selection of sources 118 to the system 400, and the system 400 receives 315 the first selection of sources 118. The system 400 thereafter sends 320 a request to the user device 410 for a plurality of initial search criteria 128, and the user device 410 receives 321 such request. Later, the user device 410 sends 324 the plurality of initial search criteria 128 to the system 400, and the system 400 receives 325 the plurality of initial search criteria 128.

The system 400 sends 330 a plurality of pre-processing parameters to the user device 410, and the user device 410 receives 331 the plurality of pre-processing parameters. Thereafter, the user device 410 sends 334 to the system 400 a first selection of the plurality of pre-processing parameters 138, and the system 400 receives 335 the first selection of the plurality of pre-processing parameters 138. The system 400 later sends 350 a first plurality of training data 142 to the user device 410, along with a plurality of selectors, e.g., checkboxes, which the user device 410 may use to collect input on the relevance or utility of each result in the first plurality of training data 142, and/or confidence interval scores or metadata, and the user device 410 receives 351 the first plurality of training data 142, along with the plurality of selectors, confidence interval scores, and/or metadata. Later, the user device 410 sends 354 to the system 400 the first plurality of selections 158 of the first plurality of training data 142, and the system receives 355 the same.

In some embodiments of the present invention, the system 400 and the user device 410 may iterate the steps of sending 330, receiving 331, sending 334, and receiving 335, to communicate a next plurality of processing parameters, and/or may iterate the steps of sending 350, receiving 351, sending 354, and receiving 355, to send feedback on a new plurality of training data 168.

Thereafter, the system 400 sends 383 a plurality of validation output 184 to the user device 410, and the user device 410 receives 384 the plurality of validation output 184. The user device 410 later sends 386 to the system 400 a plurality of validation responses 188 from a user regarding the accuracy of the validation output 184, and the system 400 receives 387 the plurality of validation responses 188. These steps, of sending 383, receiving 384, sending 386, and receiving 387, may be iterated by the user until satisfied with the accuracy and relevance of the model output 152, or as many times as the user wishes to iterate. The inventive methods allow a user, using a user device 410, to revisit any feedback the user has given on any previous training data or model output 152.

### Example 2

### Model Aggregation System/Tool of the Present Invention

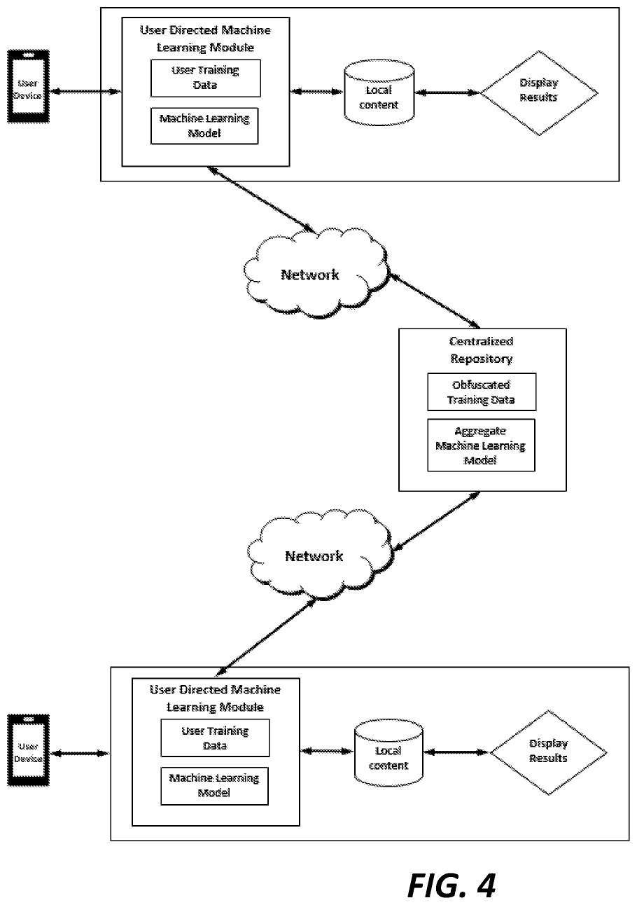

FIG. 4 illustrates a representative embodiment of the model aggregation system/tool of the present invention, depicting components of the inventive system, and elements external to such components. This figure depicts the interface of one user on a user device that creates a first user-directed iterative machine learning model that is then encapsulated by data obfuscation, and uploaded to centralized repository. This centralized repository is accessible by a second user for downloading by the second user device for application or additional validation. The additional validation aggregates the initial encapsulated model with the training data set of the second user to produce an aggregated user-directed iterative machine learning model.

The aggregated user-directed iterative machine learning model may be further obfuscated to create an aggregated encapsulated model that is suitable for aggregation with additional training data to form a second aggregated user-directed iterative machine learning model. This second aggregated encapsulated model may be uploaded to the initial centralized repository.

### Example 3

### Examples of Use of Model Aggregation Tools of the Present Invention

The model aggregation tools of the present invention may be used to provide a system of supervision that allows the predictive capabilities of the user-directed iterative machine learning model to remain dynamic (i.e. as additional users provide new input/feedback based on new circumstances), the model remains “fresh” and evolves over time based on the user population consensus. In this way, the model aggregation takes advantage of the “wisdom of crowds”—i.e., with a consensus of large volumes of data from multiple users, the system moves the model curve to where the propensity of the data lies, excluding the outliers

One exemplary embodiment of the invention may be utilized by a compliance department in a financial services firm is required to implement a “reasonable system of supervision” to identify potentially illegal transactions (fraud, insider trading, etc.). The model aggregation tools of the present invention provide the opportunity to do so by increasing in an exponential fashion the predictive qualities of the aggregated models over time given a multi-user environment, i.e., producing increasingly better results upon application of the model.

This tool affords increased application of the process of “reducing the haystack” for the user, i.e., filtering out obvious false positives (e.g., valid trades or non-suspicious communications) so that users can focus on high-value analysis of the remaining data that humans are better at, which requires interpretation, judgement and experience, e.g., with as few as 100 examples instead of millions.

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

The description itself is not intended to limit the scope of this disclosure. Rather, the present invention might also be embodied in other ways, to include different steps or elements similar to the ones described herein, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

What is claimed is:

1. A model aggregation tool utilizing model encapsulation of user-directed iterative (UDI) machine learning comprising a machine-readable medium having instructions stored thereon for execution by a processor to perform a method of model encapsulation of user-directed iterative machine learning comprising the steps of
establishing user elected search criteria to create a primary machine learning model;
training the primary machine learning model with a reference subset based on a comparative scoring analysis to produce a first training data set;
validating the first training data set within a database by user direction to create a user-directed machine learning model;
training the user-directed machine learning model with a second reference subset based on comparative scoring to produce a second training data set;
validating the second training data set within the database by user direction to create a first user-directed iterative machine learning model; and
obfuscating the first and second training data sets of the first user-directed iterative machine learning model to create an encapsulated model,
such that the user-directed iterative (UDI) machine learning is used to create encapsulated models suitable for aggregation with additional training data to form an aggregated user-directed iterative machine learning model.

2. The model aggregation tool of claim 1, wherein the method further comprises the step of uploading the encapsulated model into a centralized repository useful for sharing encapsulated models.

3. The model aggregation tool of claim 1, wherein the method further comprises the step of downloading the encapsulated model and applying said encapsulated model to a second database of a second user, wherein a second results data set is established for the second database.

4. The model aggregation tool of claim 1, wherein the method further comprises the step of downloading the encapsulated model and aggregation of the encapsulation model with a third training data set within a second database of a second user by user direction of a second user to create an aggregated user-directed iterative machine learning model.

5. The model aggregation tool of claim 4, wherein the method further comprises the step of obfuscating the third training data set of the aggregated user-directed iterative machine learning model to create an aggregated encapsulated model, wherein such aggregated encapsulated model is suitable for aggregation with additional training data to form a second aggregated user-directed iterative machine learning model.

6. The model aggregation tool of claim 5, wherein the method further comprises the step of uploading the aggregated encapsulated model into a second centralized repository useful for sharing aggregated encapsulated models.

7. The model aggregation tool of claim 1, wherein the method further comprises the step of providing an interface for the second user to access the centralized repository.

8. The model aggregation tool of claim 1, wherein the method further comprises the step of providing an interface for the second user to apply or validate an encapsulated model using a data set.

9. The model aggregation tool of claim 1, wherein the tool is designed for use in detection or prevention of fraud, risk analysis, or compliance.

10. (canceled)

11. The model aggregation tool of claim 1, wherein the method further comprises the step of further training the first user-directed machine learning model with one or more additional reference subsets based on comparative scoring to produce additional training data sets; validating the additional training data sets by user direction to create a modified user-directed iterative machine learning model; and obfuscating said modified user-directed iterative machine learning model.

12. (canceled)

13. (canceled)

14. The model aggregation tool of claim 1, wherein the database comprises source content selected from the group consisting of consumer content, business content, news content, education content, and scientific content.

15. The model aggregation tool of claim 1, wherein the user elected search criteria is selected from the group consisting of keywords, source content, confidence threshold, and number of occurrences.

16. The model aggregation tool of claim 1, wherein the method further comprises the step of providing an interface for the user to establish the user search criteria.

17. (canceled)

18. (canceled)

19. (canceled)

20. A method of model encapsulation of user-directed iterative machine learning comprising the steps of:
establishing user elected search criteria to create a primary machine learning model;
training the primary machine learning model with a reference subset based on a comparative scoring analysis to produce a first training data set;
validating the first training data set within a database by user direction to create a user-directed machine learning model;
training the user-directed machine learning model with a second reference subset based on comparative scoring to produce a second training data set;
validating the second training data set within the database by user direction to create a first user-directed iterative machine learning model; and
obfuscating the first and second training data sets of the first user-directed iterative machine learning model to create an encapsulated model,
such that the user-directed iterative (UDI) machine learning is used to create encapsulated models suitable for aggregation with additional training data to form an aggregated user-directed iterative machine learning model.

21. The method of claim 20 further comprising the step of uploading the encapsulated model into a centralized repository useful for sharing encapsulated models.

22. The method of claim 20, further comprising the step of downloading the encapsulated model and applying said encapsulated model to a second database of a second user, wherein a second results data set is established for the second database.

23. The method of claim 20, further comprising the step of downloading the encapsulated model and aggregation of the encapsulation model with a third training data set within a second database of a second user by user direction of a second user to create an aggregated user-directed iterative machine learning model.

24. The method of claim 23, further comprising the step of obfuscating the third training data set of the aggregated user-directed iterative machine learning model to create an aggregated encapsulated model, wherein such aggregated encapsulated model is suitable for aggregation with additional training data to form a second aggregated user-directed iterative machine learning model.

25. The method of claim 24, further comprising the step of uploading the aggregated encapsulated model into a second centralized repository useful for sharing aggregated encapsulated models.

26. The method of claim 20, further comprising the step of providing an interface for the second user to access the centralized repository.

27. The method of claim 20, further comprising the step of providing an interface for the second user to apply or validate an encapsulated model using a data set.

28. The method of claim 20, wherein the method is designed for use in detection or prevention of fraud, risk analysis, or compliance.

29. (canceled)

30. The method of claim 20, further comprising the step of further training the first user-directed machine learning model with one or more additional reference subsets based on comparative scoring to produce additional training data sets; validating the additional training data sets by user direction to create a modified user-directed iterative machine learning model; and obfuscating said modified user-directed iterative machine learning model.

31. (canceled)

32. (canceled)

33. The method of claim 20, wherein the database comprises source content selected from the group consisting of consumer content, business content, news content, education content, and scientific content.

34. The method of claim 20, wherein the user elected search criteria is selected from the group consisting of keywords, source content, confidence threshold, and number of occurrences.

35. (canceled)

36. (canceled)
